(19) United States
(12) Patent Application Publication
(10) Pub. No.: US 2013/0037420 A1
(43) Pub. Date: Feb. 14, 2013

(54) METHOD AND APPARATUS FOR DETECTING MOISTURE ON METAL AND OTHER SURFACES, INCLUDING SURFACES UNDER THERMAL INSULATION

(71) Applicant: Miki Funahashi, West Chester, PA (US)

(72) Inventor: Miki Funahashi, West Chester, PA (US)

(21) Appl. No.: 13/207,042

(22) Filed: Aug. 10, 2011

(51) Int. Cl. G01N 27/26

(52) U.S. Cl. 205/775.5; 204/404

(57) ABSTRACT

Systems and methods are disclosed for detecting the presence of water on or in pipelines, tanks, equipment and other structures, including insulated structures which may be subject to corrosion under insulation, or CUI. Two dissimilar, spaced-apart metals are coupled at least indirectly to a structure to be monitored, and apparatus for detecting a potential difference between the two dissimilar metals, thereby indicating that water is present as an electrolyte. In CUI applications, at least one of the dissimilar metals is attached to, or embedded within, a water-absorbing insulator or other material coupled to or surrounding the structure. The water-absorbing material may be provided in the form of a tape attached to the surface of a metal component fanning the structure. In some embodiments, the structure to be monitored may itself incorporate a ferrous metal component which is used as one of the dissimilar metals.

### FIELD OF THE INVENTION

This invention relates to water detection and, in particular, to the detection of moisture on metal pipelines, tanks, equipment and structures which cannot readily be inspected by detecting the voltage difference between dissimilar metals when water is present as the electrolyte.

### BACKGROUND OF THE INVENTION

The corrosion of pipes, tanks and various equipment under thermal insulation has been a significant problem in the petrochemical and other industries. When such metal structures are covered with thermal insulation, leak detection due to corrosive failure is often too late because the corrosion under insulation (CUI) cannot be visually inspected without removing the insulation material. The lengthy and high cost of corrosion repairs and inspection results in huge financial losses and manufacturing downtime.

To initiate and sustain corrosion, an ionic conductance material—i.e., an electrolyte—is required. The electrolyte for CUI is typically moisture or water resulting from the intrusion of rain water, deluge system water, wash water, or condensation. In ideal situations, the insulation system should be water tight; however, the failure of water tightness occurs in some areas, resulting in water intrusion. In addition, condensation on the cold pipelines, non-operating pipelines, or cyclic hot-and-cold pipeline is another source of the CUI electrolyte.

The insulator system typically consists of a thermal substance and a thin metal sheathing. Some types of insulation also incorporate aluminum mesh. Typical insulation material is low in density to limit air movement, and some contain gases to minimize the heat flow. This latter type of insulation holds moisture like a sponge. Even in non-sponge-like insulator materials, when water intrudes under the insulator, it may accumulate in the lower portion of the pipelines, tanks, or equipment, resulting in corrosion and leaks.

Another important factor is how long the area has been wet. The longer steel is exposed to water, the faster the CUI progresses. Therefore, it is important to know the wet duration time and frequency for a particular section of a pipeline or other metal surface.

It is not economical, and highly time consuming, to visually insect multiple sections of a pipeline by removing the insulation. A number of non-destructive inspection methods have been proposed and patented to inspect for CUI, including acoustic emission, infrared imaging, radiography, ultrasonic testing, eddy current techniques, and so forth. However, some pipelines are a few kilometers long, and some pipelines are positioned 30 to 40 m above ground. Furthermore, inspections are difficult due to the limited access in highly congested areas. In some cases, CUI may be detected in a few percent of an entire pipeline after several years of inspection time. Moreover, when the visual inspection is carried out by removing the insulation, the integrity of the water tightness may be disrupted.

Various water monitors have therefore been developed. Water detection monitors for pipelines are usually positioned at the lowest point of the pipeline through a funnel. When sufficient water is collected, a floating-switch is turned on inside the monitor and an indicator light is lit. However, with such systems water leaks in non-monitored areas may be occurring without detection. In addition, moisture due to condensation on the pipe surface or if only a small amount of water is present under the insulation, the amount of moisture may not be sufficient for detection purposes even though this amount of water is sufficient for localized CUI.

Another serious problem caused by water leaks is associated with tunnel structures. When concrete tunnels are constructed under the sea or in underground water containing salt, waterproof membranes are used to protect the internal space of the tunnel from water ingress. However, water leaks in the waterproof membranes may develop due to the defects in some areas caused by structural damage, soil movement or deterioration due to age. The water may cause severe corrosion of the reinforcing steel bar (rebar) in the concrete, particularly in the roof and walls. When chlorides in water penetrate into concrete and reach to the rebar, the corrosion products of the rebar expand, resulting in concrete cracks and spalls. If the spalled concrete falls on pedestrians, automobiles or trains inside the tunnels, it may cause traffic disruption and serious injury. As such, early detection of the water leaks is important before rebar corrosion becomes a serious problem.

Yet a further concern involves the corrosion caused by water leakage in post-tensioned cables for various prestressed concrete structures, as well as the cables for suspension and cable stay bridges. These high-strength cables are protected from corrosion by shielding water intrusion from outside by polyethylene or metallic sheath. However, due to defects in the sheathing system, material deterioration due to aging, or failure of the anchoring system, water tightness may fail. Since the cable inside cannot visually inspected, expensive non-destructive inspection devices are used when the outside of the cable is accessible. However, when cables are embedded in concrete, inspection is not possible until the failure of the cable occurs.

### SUMMARY OF THE INVENTION

This invention resides in systems and methods for detecting the presence of water on or in structures with metal components subject to corrosion. The various embodiments overcome shortcomings associated with inspection methods used on pipelines, tanks, equipment and other structures, including insulated structures which may be subject to corrosion under insulation, or CUI.

A system constructed in accordance with the invention includes two dissimilar, spaced-apart metals coupled at least indirectly to a structure to be monitored, and apparatus for detecting a potential difference between the two dissimilar metals, thereby indicating that water is present as an electrolyte. In the preferred embodiments, one of the dissimilar metals at least acts as an active metal, while the other at least acts a noble metal. The dissimilar metals may be spaced apart at a width in the range from 1 mm to 10 meters and co-extensive at a length in the range of from 10 mm to 100 meters.

In CUI applications, at least one of the dissimilar metals is attached to, or embedded within, a water-absorbing insulator or other material coupled to or surrounding the structure. The water-absorbing material is not ionically conductive when dry but is ionically conductive when it is moist or wet. The water-absorbing material may be provided in the form of a tape attached to the surface of a metal component forming the structure using magnetic attraction, adhesives or mechanical fasteners.

In some embodiments, the structure to be monitored may itself incorporate a ferrous metal component which is used as one of the dissimilar metals. The apparatus for detecting a potential difference across the two dissimilar metals may be powered only by the potential difference across the two dissimilar metals; for example, a light-emitting diode powered only by the potential difference across the two dissimilar metals.

In more sophisticated monitoring environments, the apparatus further includes a remote or wireless data logger operative to log the length of time and the frequency during which the water is present to assess the risk of corrosion. A such, the invention can provide the frequency and duration of time that the structure is exposed to water moisture to determine the risk of corrosion associated with steel surfaces of entire pipelines, tanks, tunnels, post-tensioned cables, stayed cables and other vulnerable equipment. The invention can therefore be used to prioritize each section of a structure for CUI inspection, for example. By screening each segment of a pipeline, tank or equipment where the monitors are installed, the cost for the detailed inspection and testing can significantly be reduced.

### BRIEF DESCRIPTION OF THE DRAWINGS

FIG. 1A is a drawing that shows a galvanic tape constructed in accordance with the invention;

FIG. 1B illustrates a section of a steel pipe with the galvanic metals attached to the outer surface of a water-absorbing material in the form of an elongate tape that runs co-extensive with the pipeline;

FIG. 1C illustrates a section of a steel pipe with the galvanic metals embedded within the water-absorbing material configured as a lengthwise tape;

FIG. 2A is a drawing that shows a galvanic tape constructed in accordance with an alternative embodiment the invention which uses the steel structure itself as one of the dissimilar metals, thus requiring only one additional electrode;

FIG. 2B illustrates a section of a steel pipe with the galvanic metal of FIG. 2A attached to the outer surface of a water-absorbing material in the form of an elongate tape that runs co-extensive with the pipeline;

FIG. 2C illustrates a section of a steel pipe with the galvanic metal of FIG. 2A embedded within the water-absorbing material, also configured as a lengthwise tape;

FIG. 3 illustrates a galvanic tape installation method on a steel tank covered with thermal insulation;

FIG. 4 shows an example of galvanic tape installation inside a reinforced concrete tunnel having air vents and an outer, waterproof membrane;

FIG. 5 is a drawing that shows a data logger attached to a galvanic tape;

FIG. 6 depicts an example of a monitoring set-up for a pipeline; and

FIG. 7 illustrates a further application of the invention, namely, steel cables which may be installed inside of a sheath.

### DETAILED DESCRIPTION OF THE INVENTION

By way of background, in a given environment such as water, one metal will be either more noble or more active than the other, based on how strongly its ions are bound to the surface. Using the water as an electrolyte, the more noble metal will take electrons from the more active one. The resulting mass flow or electrical current can be measured to establish a hierarchy of materials in the medium of interest. This hierarchy is called a galvanic series, and can be a very useful in predicting and understanding corrosion.

When two dissimilar metals are surrounded by a non-electrolyte or dry material, they do not develop a potential difference between them. When the two dissimilar metals are immersed in an electrolyte, however, the potential difference between them can be measured. The present invention uses this principle. When the two dissimilar metal tapes are spaced apart and not in direct electrical contact, they show different potentials or voltage in electrolyte as indicated in the galvanic series. As such, when the water absorbing tape is moist or wet, the potential difference between the two metals (i.e., the galvanic couple) may be detected. As one example of many, the potential difference between zinc and titanium is approximately 0.7 to 1 volts in water.

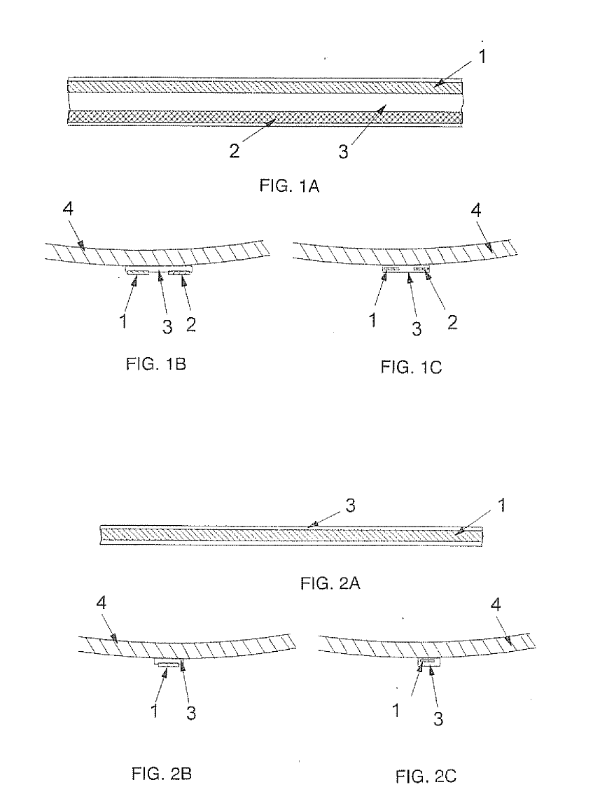

In the preferred embodiment, two dissimilar metal tapes are attached to a water absorbing tape or included in a water-absorbing cloth envelope. FIG. 1A is a drawing that shows a galvanic tape constructed in accordance with the invention. Item (1) is one of the metals and item (2) is the other. One of these metals acts as a noble metal while the other is active. Any two dissimilar metals may be used so long as they generate a potential difference in the presence of water as an electrolyte. Typical examples include zinc, aluminum, carbon, copper, titanium, iron and steel. Item 30 in FIG. 1A is a water-absorbing material such as cloth, fibers, sponge, dry gel, wood, or any porous materials.

FIG. 1B illustrates a section of a steel pipe (4), with the galvanic metals (1), (2) attached to the outer surface of a water-absorbing material (3) in the form of an elongate tape that runs co-extensive with the pipeline. FIG. 1C illustrates a section of a steel pipe (4), with the galvanic metals (1), (2) embedded within the water-absorbing material (3), again configured as a lengthwise tape.

By attaching the galvanic couple made of dissimilar metal tapes with dry water-absorbing tape, any present moisture or water can be detected by measuring the voltage. In other words, when any portion of the galvanic tape is wet or moist, regardless of the size or the extent of the wetness, the voltage difference immediately occurs. By periodically measuring or logging the voltage of the galvanic tape or envelope, the time of the wet period and the frequency can be determined. The galvanic tape or envelope can be any lengths from 5 cm to 100 m. The proper length and size of the tape or envelope can be determined based on the structure geometry, the size of structure, the risk level of the water ingress, or planned inspection or testing segments, etc.

The galvanic tape(s) can be attached on a steel surface by adhesives, magnetic tape or mechanical fasteners. For thermal insulated pipelines, the galvanic tape can be installed at the bottom portion of the pipeline, joints or any region of concern. In some embodiments of the invention, the steel pipe may itself be used as one of the dissimilar metals. As shown in FIG. 2A, this embodiment requires only one electrode (1) on (FIG. 2B) or within (FIG. 2C) a water-absorbing material (3).

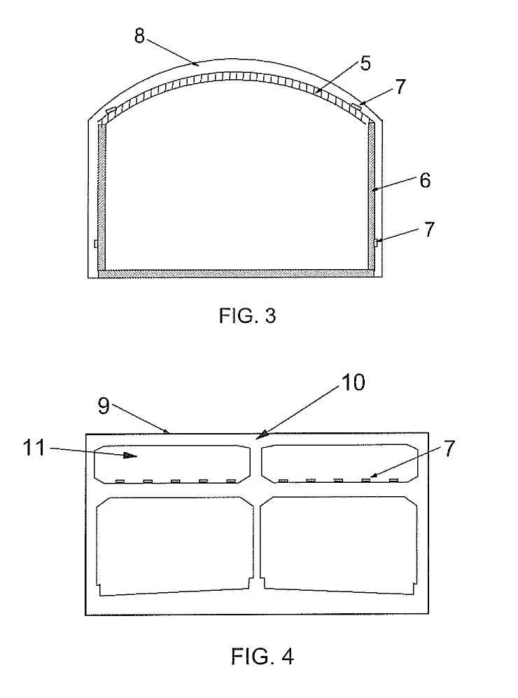

FIG. 3 illustrates a galvanic tape installation method on a steel tank (6) covered with thermal insulation (8). In these applications, the galvanic tape(s) (7) can be installed on lower portions of the walls (6) and roof (5) where water stays longer. For cyclic temperature or cold pipelines, the galvanic tape can be installed in the areas which condensation occurs.

FIG. 4 is an example of galvanic tape installation inside a reinforced concrete tunnel (10) having air vents (11) and an outer, waterproof membrane (9). For concrete tunnel structures, the galvanic tape(s) (7) can be installed on the top of a ceiling slab or inner face of the tunnel shells where any water leakage may be of concern.

FIG. 7 illustrates a further application of the invention, namely, steel cables (15). In cases where the cables (15) need water-tightness, the galvanic tape(s) can be installed inside the sheath (14), which is sometimes filled with cementitious grout or corrosion inhibitor grease. When fresh grout is injected, the galvanic tape may be activated. However, with the curing of the grout, the moisture of the grout eventually dries out and the voltage difference decreases. When the galvanic tape is wet during the structure life, the voltage difference increases again, indicating the new moisture inside the sheath.

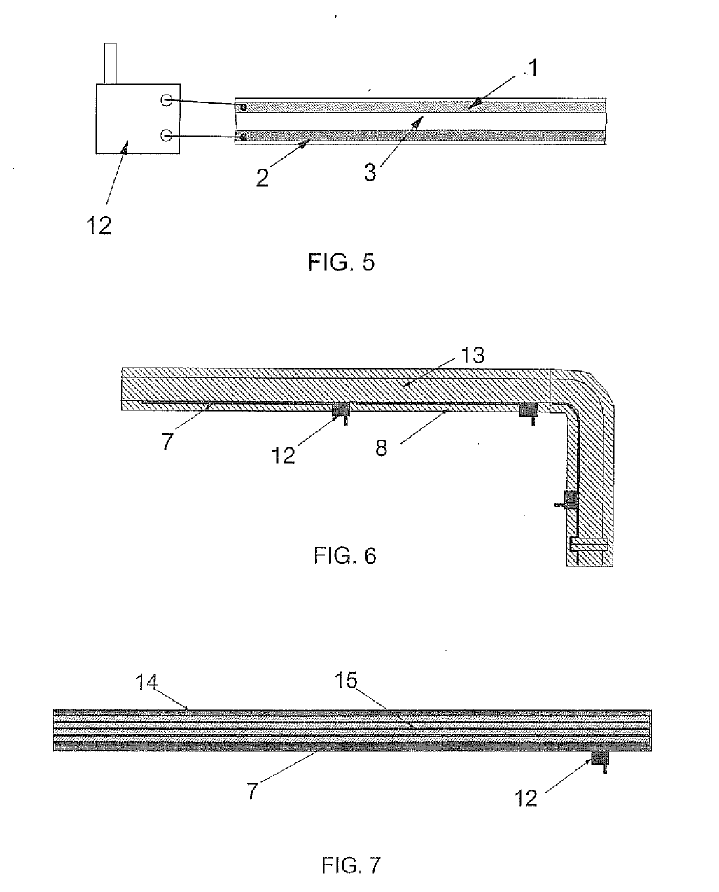

In all embodiments of the invention, the potential difference may be detected or measured with devices ranging from simple detectors to sophisticated instruments. FIG. 5 is an example of data logger (12) attached to galvanic tape. FIG. 6 is an example of monitoring set-up for a portion of pipeline (13) wherein multiple data loggers may be deployed. After the data is collected during a particular time period, the information may be transmitted to a computer by wires or wireless for the data analysis. Based on the frequency of wetness and the wet duration of time, the priority of the inspection segments or locations can be determined before a detailed inspection of CUI is performed.

When data logging is not required, the galvanic tape can be used as the electrical power source, in some cases forgoing the need for a battery or separate power source. This voltage developed by the galvanic tape can be used as a power source for a signal indicator, such as LED, for example.

While the embodiments thus far described have been “passive” in the sense that a potential difference is developed through dissimilar metals based upon galvanic action with water as the electrolyte, this invention also anticipates “active” detection using a battery or any external voltage source applied to two conductors or conductive tapes. Such a power source may, in fact, form part of the monitoring or data-logging apparatus. In this embodiment, the conductors need not be dissimilar and, in fact, they need not be metal as materials such as carbon may be used. As with the passive embodiments, when any portion of the system is moist, the current flows through the electrolyte (i.e., water), thereby facilitating moisture detection.

I claim:

1. A system for detecting the presence of water on or in a structure with metal components subject to corrosion, comprising:
two dissimilar, spaced-apart metals coupled to the structure; and
apparatus for detecting a potential difference between the two dissimilar metals, thereby indicating that water is present as an electrolyte.

2. The system of claim 1, wherein one of the dissimilar metals is an active metal and the other is a noble metal.

3. The system of claim 1, wherein at least one of the dissimilar metals is attached to or embedded within a water-absorbing insulator or other material coupled to or surrounding the structure.

4. The system of claim 3, wherein the water-absorbing material is not ionically conductive when dry but is ionically conductive when it is moist or wet.

5. The system of claim 3, wherein the dissimilar metals are spaced apart and co-extensive at a length in the range of from 10 mm to 100 meters.

6. The system of claim 3, wherein the dissimilar metals are spaced apart at a width in the range from 1 mm to 10 meters.

7. The system of claim 3, wherein the water-absorbing material is in the form of a tape attached to the surface of a metal component forming the structure.

8. The system of claim 3, wherein the water-absorbing material is attached to the surface of a metal component using a magnet, adhesive or mechanical device.

9. The system of claim 1, wherein the structure incorporates a ferrous metal component which is used as one of the dissimilar metals.

10. The system of claim 1, wherein the apparatus for detecting a potential difference across the two dissimilar metals is powered only by the potential difference across the two dissimilar metals.

11. The system of claim 1, wherein the apparatus for detecting a potential difference across the two dissimilar metals is a light-emitting diode powered only by the potential difference across the two dissimilar metals.

12. The system of claim 1, wherein the apparatus further includes a data logger operative to log the length of time and the frequency during which the water is present to assess the risk of corrosion.

13. The system of claim 1, wherein the apparatus further includes a remote data logger operative to measure and transmit information relating to the length of time and the frequency during which the water is present to assess the risk of corrosion.

14. The system of claim 1, wherein the apparatus further includes a wireless data logger operative to measure and transmit information relating to the length of time and the frequency during which the water is present to assess the risk of corrosion.

15. A system for detecting the presence of water to prevent corrosion, comprising:
an elongated steel structure;
a non-ferrous metallic electrode disposed on or embedded within a water-absorbing insulator or other material attached to the structure such that the electrode is spaced apart from and not in direct electrical contact with the steel structure; and
apparatus for detecting a potential difference between the steel structure and the non-ferrous metallic electrode, thereby indicating that water is present as an electrolyte.

16. The system of claim 15, wherein the elongated steel structure is a pipeline.

17. The system of claim 15, wherein the elongated steel structure is a cable.

18. The system of claim 15, wherein the water-absorbing material is not ionically conductive when dry but is ionically conductive when it is moist or wet.

19. The system of claim 15, wherein the elongated steel structure and non-ferrous metallic electrode are co-extensive at a length in the range of from 10 mm to 100 meters.

20. The system of claim 15, wherein the elongated steel structure and non-ferrous metallic electrode are spaced apart at a width in the range from 1 mm to 10 meters.

21. The system of claim 15, wherein the water-absorbing material is in the form of a tape attached to the surface of the elongated steel structure.

22. The system of claim 15, wherein the water-absorbing material is attached to the surface of the elongated steel structure using a magnet, adhesive or mechanical device.

23. The system of claim 15, wherein the apparatus for detecting a potential difference across the two dissimilar metals is powered only by the potential difference across the two dissimilar metals.

24. The system of claim 15, wherein the apparatus for detecting a potential difference across the two dissimilar metals is a light-emitting diode powered only by the potential difference across the two dissimilar metals.

25. The system of claim 15, wherein the apparatus further includes a data logger operative to log the length of time and the frequency during which the water is present to assess the risk of corrosion.

26. The system of claim 15, wherein the apparatus further includes a remote data logger operative to measure and transmit information relating to the length of time and the frequency during which the water is present to assess the risk of corrosion.

27. The system of claim 15, wherein the apparatus further includes a wireless data logger operative to measure and transmit information relating to the length of time and the frequency during which the water is present to assess the risk of corrosion.

28. A method of detecting the presence of water on or in a structure with metal components subject to corrosion, comprising the steps of:
placing a dissimilar metal on or in the structure such that the dissimilar metal and the metal components are spaced apart and not in direct electrical contact; and
detecting a potential difference between the metal components and the dissimilar metal, thereby indicating that water is present as an electrolyte; or
placing two dissimilar metals on or in the structure such that the dissimilar metals are spaced apart and not in direct electrical contact; and
detecting a potential difference between the two dissimilar metals, thereby indicating that water is present as an electrolyte; or
placing one or more electrically conductive materials on or in the structure such that they are spaced apart and not in direct electrical contact with one another;
placing a voltage between two of the electrically conductive materials or between one of the electrically conductive materials and a metal component of the structure; and
using the change in the voltage, if any, to detect the presence of water acting as an electrolyte.

29. The method of claim 28, including the step of placing at least one of the dissimilar metals on a pipeline.

30. The method of claim 28, including the step of placing at least one of the dissimilar metals on a cable.

31. The method of claim 28, including the step of placing at least one of the dissimilar metals on concrete structure including embedded metal reinforcement rods.

32. The method of claim 28, including the step of disposing at least one of the dissimilar metals on or within a water-absorbing insulator or other material coupled to or surrounding the structure.

33. The method of claim 32, wherein the water-absorbing material is not ionically conductive when dry but is ionically conductive when it is moist or wet.

34. The method of claim 28, wherein the dissimilar metals are spaced apart and co-extensive at a length in the range of from 10 mm to 100 meters.

35. The method of claim 28, wherein the dissimilar metals are spaced apart at a width in the range from 1 mm to 10 meters.

36. The method of claim 28, wherein the water-absorbing material is in the form of a tape attached to the surface of a metal component forming the structure.

37. The method of claim 36, wherein the water-absorbing material is attached to the surface of a metal component using a magnet, adhesive or mechanical device.

38. The method of claim 28, wherein the step of detecting a potential difference between the two dissimilar metals does not use additional electrical power.

39. The method of claim 28, wherein the step of detecting a potential difference between the two dissimilar metals includes the use of a light-emitting diode powered only by the potential difference across the two dissimilar metals.

40. The method of claim 28, further including the step of providing a data logger operative to log the length of time and the frequency during which the water is present to assess the risk of corrosion.

41. The method of claim 28, further including the step of providing a remote data logger operative to measure and transmit information relating to the length of time and the frequency during which the water is present to assess the risk of corrosion.

42. The method of claim 28, further including the step of providing a wireless data logger operative to measure and transmit information relating to the length of time and the frequency during which the water is present to assess the risk of corrosion.
